(19) United States
(12) Patent Application Publication
(10) Pub. No.: US 2017/0034519 A1
(43) Pub. Date: Feb. 2, 2017

(54) METHOD, APPARATUS AND SYSTEM FOR ENCODING VIDEO DATA FOR SELECTED VIEWING CONDITIONS

(71) Applicant: CANON KABUSHIKI KAISHA, Tokyo (JP)

(72) Inventor: Christopher James Rosewarne, Concord West (AU)

(21) Appl. No.: 15/218,825

(22) Filed: Jul. 25, 2016

(30) Foreign Application Priority Data
Jul. 28, 2015 (AU) 2015207825

(51) Int. Cl. H04N 19/169; H04N 19/463; H04N 19/172

(52) U.S. Cl. CPC H04N 19/1887; H04N 19/172; H04N 19/463

(57) ABSTRACT

A method of displaying a calibrated image upon a display device comprises receiving an image for display. The image has at least a portion containing a calibration pattern with predetermined codeword values. The portion of the image is a non-displayed portion of the image, the predetermined codeword values encoding at least reference light levels of the image. The method generates a mapping for the image using the reference light levels and ambient viewing conditions associated with the display device. The mapping links codeword values of the image with light intensities of the display device; and outputs the image on the display device using the generated mapping.

### REFERENCE TO RELATED PATENT APPLICATION(S)

This application claims the benefit under 35 U.S.C. §119 of the filing date of Australian Patent Application No. 2015207825, filed Jul. 28, 2015, hereby incorporated by reference in its entirety as if fully set forth herein.

### TECHNICAL FIELD

The present invention relates generally to digital video signal processing and, in particular, to a method, apparatus and system for encoding video data with mastering environment information included to enable correct rendering of the video data by a display. The present invention also relates to a computer program product including a computer readable medium having recorded thereon a computer program for encoding video data with mastering environment information included to enable correct rendering of the video data in the display.

### BACKGROUND

Contemporary digital video systems that support capture and/or display of video data having a high dynamic range (HDR) are being released onto the market. Recently, development of standards for conveying HDR video data and development of displays capable of displaying HDR video data has begun, with an aim to specifying an interoperable standard for HDR. Standards bodies such as International Organisations for Standardisation/ International Electrotechnical Commission Joint Technical Committee 1/Subcommittee 29/ Working Group 11 (ISO/IEC JTC1/SC29/WG11), also known as the Moving Picture Experts Group (MPEG), the International Telecommunications Union—Radiocommunication Sector (ITU-R), and the Society of Motion Picture Television Experts (SMPTE) are investigating the development of standards for representation and coding of HDR video data. Companies such as Dolby, Sony, and several others, are developing displays capable of displaying HDR video data.

In traditional standard dynamic range (SDR) applications, samples in video data represent light levels in a range from a black level to a reference white level. The luminance of the black level and the reference white level is related to the environment in which the video data is captured, prepared (‘mastered’) or viewed. Note that these light levels generally differ in terms of luminance between the capture, mastering and viewing environments. In the context of SDR, it is the responsibility of the end-user to calibrate their display to produce the black level and the reference white level correctly for the ambient conditions of the viewing environment. This is achieved using a ‘brightness’ and a ‘contrast’ control by following a predefined procedure. This procedure enables the full dynamic range of the SDR video data to be perceptible in the viewing environment.

In HDR applications, samples in the video data are represented differently, due to the much increased range of allowable sample values. For example, sample values may map to specific luminances. The calibration procedure for an SDR display is no longer appropriate for HDR applications, yet viewing environments still vary widely and thus there is no guarantee that content prepared in a given mastering environment can be displayed with the dynamic range being preserved in the viewing environment.

### SUMMARY

It is an object of the present invention to substantially overcome, or at least ameliorate, one or more disadvantages of existing arrangements.

According to one aspect of the present disclosure, a method of displaying a calibrated image upon a display device, comprises: receiving an image for display, the image having at least a portion of the image containing a calibration pattern with predetermined codeword values, the at least portion of the image being a non-displayed portion of the image, the predetermined codeword values encoding at least reference light levels of the image; generating a mapping for the image using the reference light levels and ambient viewing conditions associated with the display device, the mapping linking codeword values of the image with light intensities of the display device; and outputting the image on the display device using the generated mapping.

Desirably the encoding is performed in a mastering environment. Preferably the reference light levels include at least a black level and a reference white level. Generally the display device is a high dynamic range display device. In a specific implementation, the calibration pattern is contained in an auxiliary picture. Alternatively or additionally, the calibration pattern is contained a frame packing arrangement. Preferably, the receiving comprises decoding an encoded bitstream of image data to provide the image having at least a portion containing the calibration pattern.

According to another aspect of the present disclosure there is provided a method of forming a calibrated image sequence, comprising: determining an ambient light level associated with an environment of the forming; determining reference levels from the determined ambient light level; forming a calibration test pattern associated with the reference levels; and merging the test pattern with video data of the image sequence to form the calibrated image sequence.

Desirably this method further comprises encoding the calibrated image sequence as a bitstream. Preferably the environment is one of: a capture environment in which the image sequence is captured; and a mastering environment.

Generally the merging comprises forming encoding the calibration test pattern into one of an auxiliary picture or a frame packing arrangement associated with the video data of the image sequence.

Advantageously the merging is performed by encoding video data interspersed with auxiliary pictures.

Also disclosed is a non-transitory computer readable storage medium having recorded thereon an encoded calibrated image sequence formed according to the method.

According to yet another aspect, disclosed is a display device comprising: an input for receiving an image for display, the image having at least a portion of the image containing a calibration pattern with predetermined codeword values, the at least portion of the image being a non-displayed portion of the image, the predetermined codeword values encoding at least reference light levels of the image; a light level sensor to detect ambient viewing conditions associated with the display device; a tone map generator for generating a mapping for the image using the reference light levels and the ambient viewing conditions, the mapping associating codeword values of the image with light intensities of the display device; and an output for display of the image using the generated mapping.

Preferably the output comprises: a renderer where codeword values associated with the image are rendered according to the mapping and the ambient viewing conditions; and a display panel by which the rendered codeword values are reproduced.

Advantageously the display device is a high dynamic range display device. In a specific implementation the calibration pattern is contained in one of an auxiliary picture and a frame packing arrangement. In a further example the input comprises a decoder for decoding an encoded bitstream of the image data to provide the image having at least a portion containing the calibration pattern.

Other aspects are also disclosed. One such further aspect includes an encoding device for forming the calibrated image, and another is a system including the encoding device and the display device. Another inlcudes a computer readable storage medium having a program recorded thereon, the program being executable by a processor or computer to perform one or more of the described methods.

### BRIEF DESCRIPTION OF THE DRAWINGS

At least one embodiment of the present invention will now be described with reference to the following drawings and appendices, in which:

FIG. 1 is a schematic block diagram showing a video capture and display system;

FIGS. 2A and 2B form a schematic block diagram of a general purpose computer system upon which one or both of the video capture and display system of FIG. 1 may be practiced;

FIGS. 3A, 3B, 3C and 3D are schematic diagrams showing example test patterns;

FIG. 4A is a schematic diagram showing an example frame packing arrangement of a frame of HDR video data with a displayed portion and a non-displayed portion;

FIG. 4B is schematic diagram showing example sequence of pictures with displayed frames and non-displayed frames (auxiliary pictures);

FIG. 5 is a schematic block diagram showing further detail of the video display system of FIG. 1;

FIG. 6 is a schematic flow diagram showing a method for encoding HDR video data with reference levels also encoded;

FIG. 7 is a schematic flow diagram showing a method for decoding HDR video data and rendering the video data using detected reference levels;

FIG. 8 shows a transfer function with black and reference white levels indicated; and

FIG. 9 is a schematic showing an example tone map.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Luminance is the quantitative measure of light intensity per unit area, generally measured in candela per metre² (a unit known as a “nit”), and lightness is the qualitative perceptual response to luminance. As humans have a nonlinear response to luminance, lightness (sometimes referred to as ‘brightness’) is typically approximated as a modified cube root of luminance.

In SDR applications, a generalised power law function (or ‘gamma correction’, as the exponent of the power function is gamma) is defined that provides a coarse approximation of perceptual uniform sample spacing. In other words, each increment of one sample provides roughly uniform perceived increase in lightness. ITU-R BT.709 defines an Optical-to-Electrical Transfer Function (OETF) that has a modified power function with a linear portion for low light levels. The OETF is used in a capture device, such as a video camera, to map received pixel luminance levels to a perceptual space that is then quantised to codewords within a range dependent upon the bit-depth of an encoder in the capture device. The OETF maps light levels in a capture environment (i.e. the environment in which a camera operates) to codeword values and is thus considered a mapping to ‘scene referred’ luminance levels. ITU-R BT.1886 defines an Electrical-to-Optical Transfer Function (EOTF) that models a legacy cathode ray tube (CRT) display, the EOTF being a power function with no linear portion. The EOTF maps codewords to light levels in a viewing environment, generally much dimmer than the capture environment, and thus the EOTF is said to present a ‘display referred’ representation of the image. The OETF of BT.709 and the EOTF of BT.1886 are not linear inverses of each other (i.e. even allowing for a shift in the black level and reference white level in accordance with the discrepancy between the capture environment and the viewing environment). These two functions, when combined, produce an overall transfer function or ‘Optical-to-Optical Transfer Function’ (OOTF) that can be approximated by a power function with an exponent that is sometimes referred to as the ‘system gamma’. The non-linear system gamma aspect of the overall OOTF is required to compensate for the way the human visual system perceives contrast. Display-referred luminance levels, as present in the viewing environment, are much lower than the scene-referred luminance levels present in the capture environment. If a linear system transfer function (corresponding to a system gamma of 1.0) is applied this results in a ‘washed out’ appearance because the human visual system perceives a loss of colorfulness of images at lower luminances. This phenomenon is known as the ‘Hunt effect’. Additionally, the human visual system perceives less contrast in low ambient light environments, known as the ‘Stevens effect’, exacerbating the washed out appearance. In BT.709 and BT.1886, the black level and reference white level are only defined in absolute terms for a ‘mastering environment’. The generalised definition of the black level and the reference white level are in relative terms and thus, when capturing video data and displaying video data, a scaling operation is needed to map luminances in the respective environments prior to applying the OETF or after applying the EOTF. Moreover, the encoded luminance (codeword) values, used for compressed transmission and/or storage of video data between capture/mastering and display, cannot be mapped to light levels in either the capture environment or the display environment without knowledge of the respective ambient conditions.

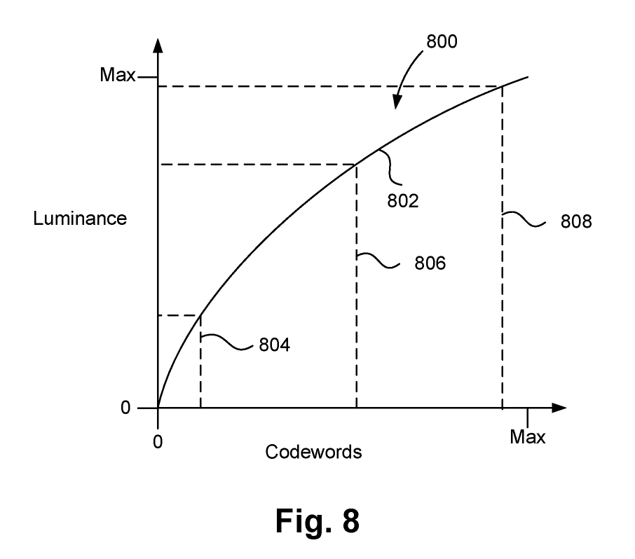

An HDR display device is capable of producing a peak luminance output that is much higher than reference white of an SDR display device. This increased output capability enables reproduction of effects such as ‘specular highlights’. Accordingly, to differentiate between the two levels the terminology of ‘peak white’ for the peak luminance and ‘reference diffuse white’ for the reference white level are used. In a HDR system, the EOTF of BT.1886 and the OETF of BT.709 cannot be applied from the black level to the peak white level. This is due to a majority of the video data lying in the portion of the EOTF and OETF range that is between the black level and the reference diffuse white level. This portion of the EOTF and OETF range does not apply the required system gamma for the range from black to reference diffuse white. Moreover, application of a conventional BT.709 OETF and BT.1886 EOTFs to the range from black to peak white would allocate insufficient codewords to the portion of the range from black to reference diffuse white when quantised to bit-depths commonly used in video compression (e.g. 8- or 10-bits). Alternative transfer functions may instead be used. For example, the ‘perceptual quantizer’ (PQ-EOTF) defined in SMPTE ST.2084 and described later with reference to FIG. 8, is designed based upon Barton's model of visual perception to provide a more perceptually uniform spacing of codewords across the considered range (up to 10000 nits). The PQ-EOTF is mapped to codewords for a specific bit-depth, e.g. 10- or 12-bit. In contrast to BT.709 and BT.1886, codewords for PQ-EOTF map to specific (or ‘absolute’) luminance levels. In the absence of further processing in a display device, the ambient viewing environment must be controlled to reproduce the intended perceptual reproduction of the video content.

Additionally, the PQ-EOTF may be applied to a reduced range using a ‘Mastering display colour volume’ SEI message, the use of which is standardised in SMPTE ST.2086. The mastering display colour volume SEI message, when included in a bitstream, indicates the peak luminance of a mastering display, as used in a mastering environment. The PQ-EOTF is linearly scaled from the default 10000 nit peak luminance to the peak luminance as signalled in the mastering display colour volume SEI message. Exemplary peak luminances include 500 nits, 1K nits, 2K nits and 4K nits. These exemplary peak luminances are used in colour grading (one aspect of mastering) software, such as DaVinci Resolve™ (Blackmagic Design Pty. Ltd).

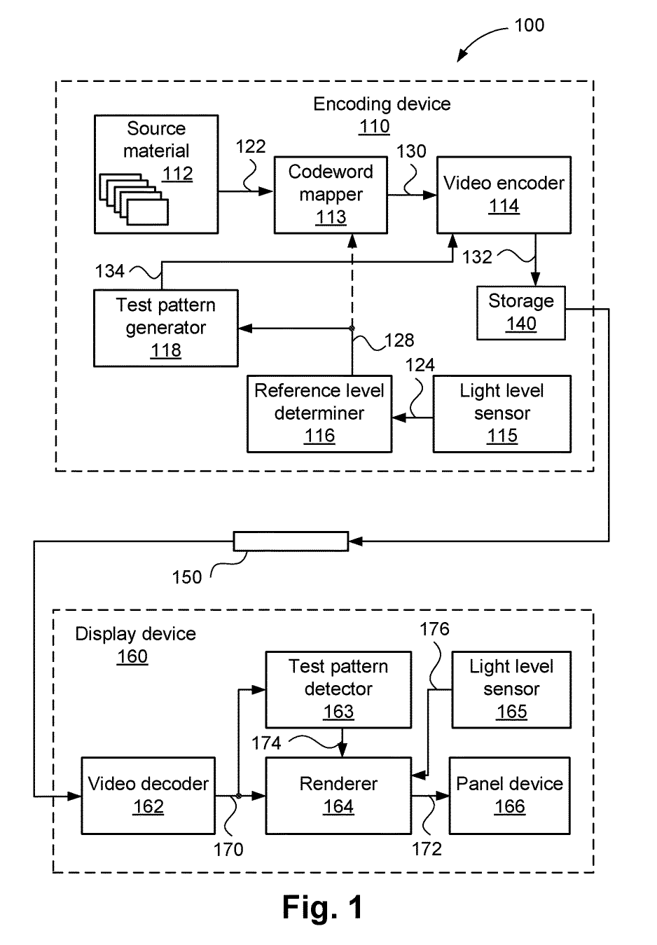

FIG. 1 is a schematic block diagram showing functional modules of a video encoding and decoding system 100. The system 100 includes an encoding device 110, a display device 160, and a communication channel 150 interconnecting the two. Examples of the encoding device 110 include a camera operating in a capture environment or a broadcast encoder. A broadcast encoder would generally be used in a studio after mastering (e.g. colour grading) the content in a mastering environment or studio to prepare various video data inputs into video data output suitable for encoding and eventually for consumption by end-users. Generally, the encoding device 110 operates at a separate location (and time) to the display device 160. Moreover, a given display device 160 will be required to display content originating from multiple encoding devices, e.g. due to selection of different channels in broadcast and a given channel containing content from a variety of sources. As such, the system 100 generally includes separate devices operating at different times and locations. Moreover, the viewing conditions at the display device 160 are generally not available to the encoding device 110. The encoding device 110 operates on source material 112. The source material 112 is generally video data from a variety of sources, captured under a variety of conditions. The source material 112 contains HDR images 122, each HDR image 122 including HDR samples. Consecutive HDR images 122 are formed into video data 130 that is represented by codewords, by a codeword mapper 113 as discussed above.

The HDR samples from the source material 112 are representative of the light levels, e.g. in three colour channels, with sampling applied horizontally and vertically to form two dimension planes of samples in each colour channel. Three planes of samples form each HDR image 122. The collocated samples of the three planes of samples form ‘pixels’, and may be said to have ‘pixel values’ that comprise the values of the samples in the respective colour planes. Perceptually, a pixel has a single colour, dependent on the associated sample values. The HDR samples are generally in a ‘linear’ domain, representative of the luminance (physical level of light) in the scene, as opposed to a ‘perceptual’ domain, representative of human perception of light levels. The HDR image 122 may be produced, e.g., by synthesising a given frame from multiple SDR images taken simultaneously, or near simultaneously, and each captured with a different exposure or ‘ISO’ setting. An alternative approach involves using a single image having SDR samples, but with different samples within the image captured at different exposures, and then synthesising an HDR image from this composite-exposure image.

The codeword mapper 113 converts the HDR images 122 into video data 130, in the form of codewords (i.e. each frame is mapped into arrays of codewords corresponding to each colour channel of the frame). The codeword mapper 113 scales the HDR images 130 in accordance with reference levels 128, described further below. The codeword mapper 113 implements the OETF that maps scene referred linear light (or values representative of linear light levels) to an approximately perceptually uniform space. The HDR images 122 are typically provided as video data 130 in a codeword form to a video encoder 114 (i.e. after application of an OETF and quantisation to a given bit-depth).

The encoding device 110 of FIG. 1 also includes a light level sensor 115. The light level sensor 115 is used to detect an ambient light level 124 in the mastering environment. Note that in controlled environments such as in a mastering environment, the light level sensor 115 may be omitted and an environment defined constant value used instead. However, when the encoding device 110 is a capture device (camera), operating in a capture environment, the light level sensor 115 is generally needed to determine ambient conditions independently from light levels reaching the sensor and thus present in the source material 112. For example, when the operator of a camera encoding device 110 is panning within a room past a window with bright external illumination, the ambient capture condition within the room will not change, even though the light intensities present in the source material 112 will vary substantially. In a professional setting, the operator of an encoding device 110 (i.e. a camera) may manually configure the encoding device 110 according to the ambient capture conditions, e.g. as measured using a separate light meter.

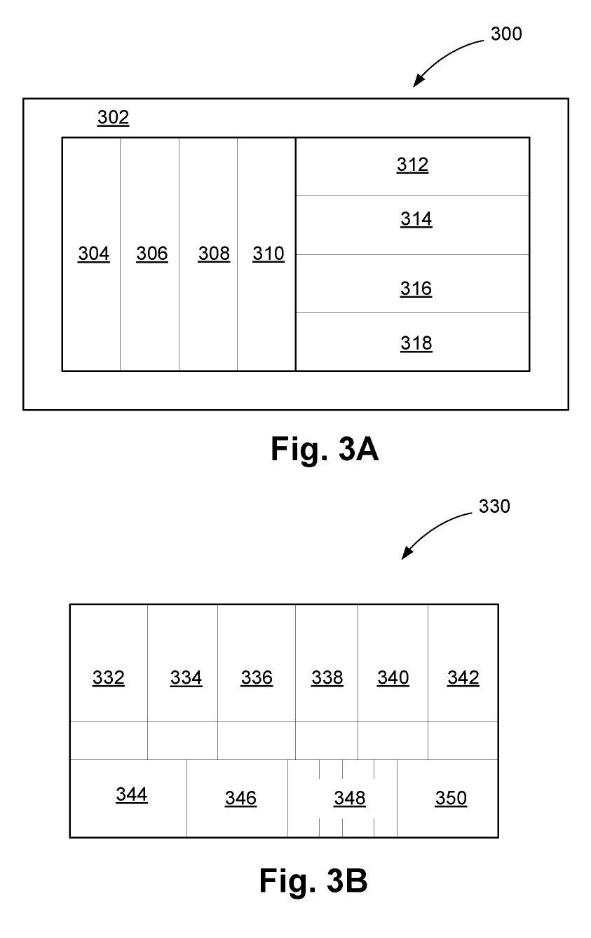

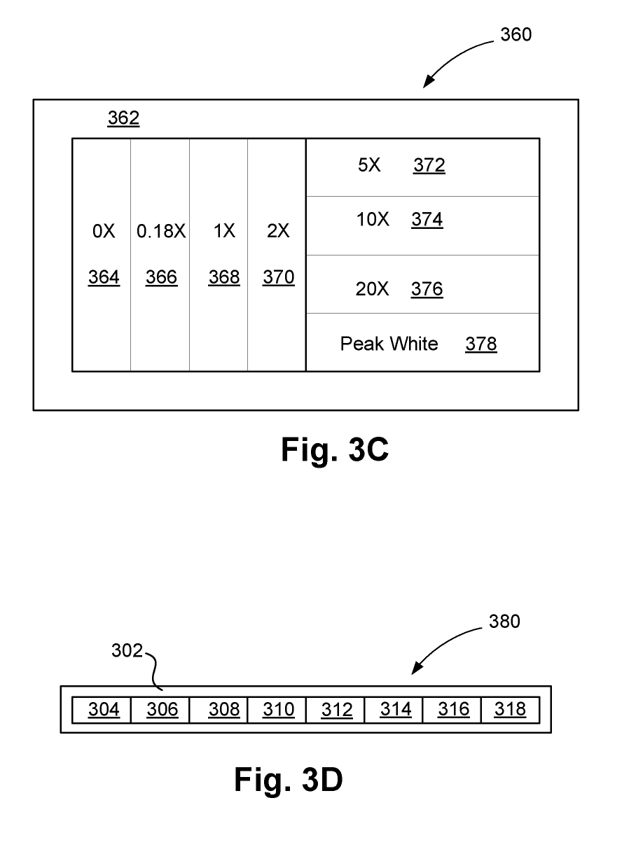

The encoding device 110 also includes a reference level determiner 116. The reference level determiner 116 determines reference levels 128, including the light level corresponding to reference black, and the light level corresponding to reference diffuse white, according to the light level 124. The encoding device 110 includes a test pattern generator 118. The test pattern generator 118 generates a test pattern that encodes the reference levels 128, i.e. the reference black level, the reference diffuse white level and the peak white level according to the mastering environment in accordance with a particular test pattern, as described with reference to FIGS. 3A-3D. As seen in FIG. 1, the video encoder 114 encodes the HDR images 122 of the video data 130 from the source material 112 and the test patterns 134 from the test pattern generator 118 to thereby form a calibrated image for each image frame of the source material. The video encoder 114 produces an encoded bitstream 132. The encoded bitstream 132 is typically stored in a storage device 140. The storage device 140 is non-transitory and can include a hard disk drive, electronic memory such as dynamic RAM, writeable optical disk or memory buffers. The encoded bitstream 132 may also be transmitted via a communication channel 150. The communication channel 150 may also include a storage device, or system, akin to the storage device 140, whereby an encoded video sequence may be stored for subsequent broadcast or distribution to one or more of the display devices 160.

Samples associated with the HDR images 122 from the source material 112 are represented as codewords, as noted above. Each codeword is an integer having a range implied by the bit-depth of the video encoder 114. For example, when the video encoder 114 is configured to operate at a bit-depth of 10-bits, an implied codeword range is from 0 to 1023. Accordingly, samples as captured by a camera may be quantised (simply compressed) into codeword values, within the available codeword range, depending upon the dynamic range of the imaging sensor of the camera. Notwithstanding the range implied by the bit-depth, generally a narrower range is used in practice. Use of a narrower range allows non-linear filtering of codeword values without risk of exceeding the implied range. Also, some codeword values may be reserved for synchronisation purposes and are thus unavailable for representing luminance levels.

Two approaches to representing luminance levels are possible: Absolute luminance and relative luminance. In the absolute luminance case, each codeword corresponds to a particular luminance to be emitted from an output formed typically by a panel device 166. The video encoder 114 encodes video data 130. The video data 130 includes samples values, mapped to codeword values in accordance with the OETF and calibrated according to the reference levels 128 output from the reference level determiner 116. In the relative luminance case, the encoded codeword values indicate luminance levels relative to a given ambient light level 124. A specific codeword value represents the black level in a given environment (i.e. the maximum light emission from a display that is indistinguishable from ambient light and this thus is effectively ‘black’), and another codeword value represents the reference diffuse white level in a given environment. As defined in ITU-R BT.2035, in a room with 10 lux illumination, the reference white level should be 100 nits. For a 10-bit coding in the Serial Digital Interface (SDI) protocol, black would be assigned the minimum codeword value of 4 (codeword values 0 to 3 are reserved for synchronisation), while a reference diffuse white defined to be 100 nits would be the codeword 520. The mapping of a given codeword value to a luminance level to be output from the panel device 166 is thus dependent on the environment condition present at the display device 160. When conveying codewords over HDMI, a narrow range of codewords is used, generally 64-940 for 10-bit codeword values. The panel device 166 emits light using an array of pixels. Each pixel outputs light including a red, green and blue component. The intensity of each component is defined in accordance with the EOTF currently in use by the display device 166.

The mastering environment generally includes a reference monitor or ‘mastering display’ (not illustrated in FIG. 1) that is used by a colourist when editing and adjusting source material 112 prior to encoding and transmission. The reference monitor is a display device capable of displaying light according to codeword values, e.g. as conveyed over an interface such as HDMI or SDI. In contrast to a consumer display, which may perform various image enhancement functions and thus deviate from the specified EOTF, a reference monitor performs no extra processing prior to display and thus accords with a specified EOTF. The reference monitor has a particular peak luminance capability and operates in the mastering environment. Thus, the above noted luminance corresponding to black and reference diffuse white is dependent upon ambient conditions in the mastering environment, and so the codewords corresponding to these levels are dependent on the mastering environment. The mastering environment, although being a well-defined environment, in practice may deviate from a preferred specified environment due to practical considerations. For example, when performing an on-site live recording or broadcast, limited mastering may take place in a mobile vehicle where the conditions are not highly controlled, and certainly not to the extent of a purpose-built mastering studio.

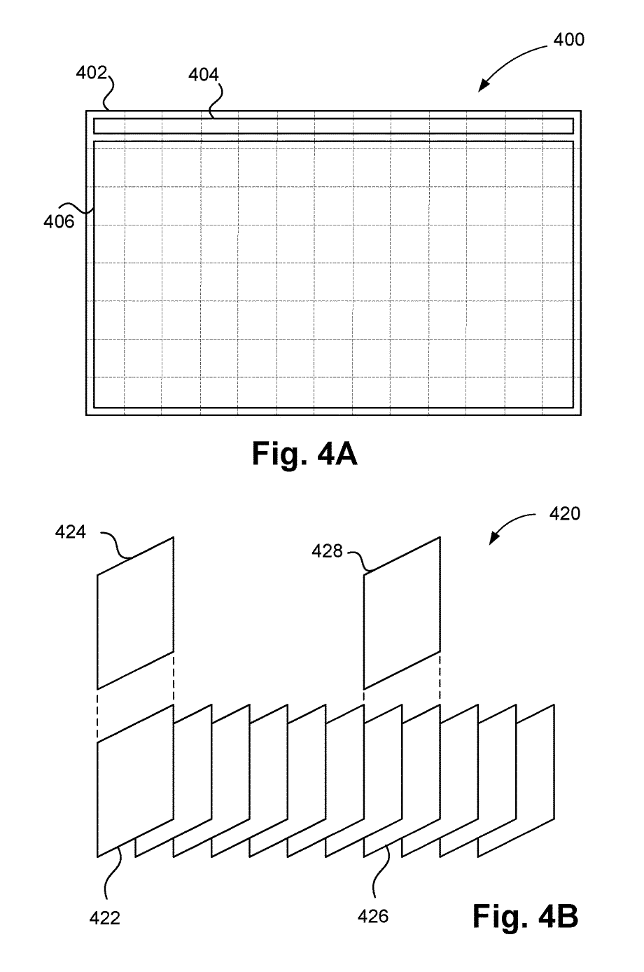

In one arrangement of the encoding device 110 the ambient light levels in the mastering environment are controlled and are known to the encoding device 110. In such arrangements, the light level sensor 115 can be omitted and the reference level determiner 116 generates reference levels corresponding to the assumed (i.e. predetermined or specified) light levels of the mastering environment. For example, the assumed light levels may be the black level, the reference diffuse white level and the peak white level. The black level is the maximum light level emitted from the display while maintaining the appearance of ‘black’. This level is highly dependent on the ambient light level in the mastering environment, as light emitted from the display at levels below the ambient light level will not be visible. In traditional SDR television, reference white is defined as the maximum white colour that can be reproduced, and as such there is no separate concept of ‘peak white’. In the context of HDR, this definition is no longer appropriate because the maximum light level is dependent on the particular display and most sample luminance is concentrated far below this maximum light level. Most sample luminance is concentrated between black and a luminance corresponding to the reference white of SDR television, so the concept of ‘reference diffuse white’ is applied in HDR television to define the perceptual range used by the majority of the video data, i.e. the majority of the codeword values correspond to the range of luminances from reference black to reference diffuse white. Excursions beyond reference diffuse white are possible, with video content features such as ‘specular highlights’ exceeding the reference diffuse white and potentially resulting in output of the maximum luminance the display is capable of producing. Perceptual studies with custom display equipment, documented in ITU-R 6C/77, indicate an average viewer preference of 650 candela/metre² (nits) for diffuse white, and 12,000 candela/metre² (nits) for specular highlights. To satisfy preferences of the upper quartile of viewers, still higher brightness is required. However, several iterations of display technology are expected before this level is achieved. In the interim (and in particular market segments), displays would generally attenuate the video data such that black and reference diffuse white were reproduced accurately, and specular highlights (and other HDR-related artefacts) would be reproduced to the extent possible on a given device. Thus, a need to maintain correct luminance levels at black and reference diffuse white remains. For an absolute luminance system, the codewords corresponding to black and reference diffuse white are not fixed. Thus, the encoding device 110 includes the reference level determiner 116 that produces the codewords corresponding to black, reference diffuse white and peak white in the mastering environment (or the capture environment, in the case of encoding video data directly for broadcast, e.g. for live broadcast). The test pattern generator 118 produces a test pattern (e.g. 404 of FIG. 4A or 424, 428 of FIG. 4B) using the black level, the reference diffuse white level and, in some arrangements, the peak white level. The test pattern generator 118 may also generate colour bars in the test pattern using the white point as a reference point for each of the colours in the colour bars. An image combiner (not shown but present as part of the video encoder 114) combines the HDR image 122 with the test pattern 134 to produce a combined image. In one arrangement of the encoding device 110, the combined image includes a non-displayed portion that contains the test pattern. In another arrangement of the encoding device 110, the test pattern is included into a sequence of frames of video data as an auxiliary image, e.g. as described later with reference to FIG. 4B. Then, the video encoder 114 encodes a sequence of combined images to produce an encoded bitstream 132.

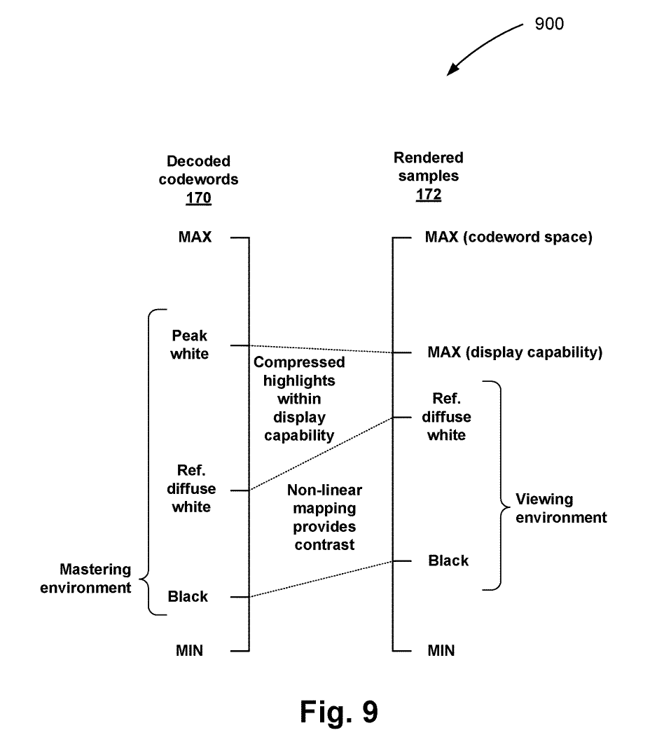

The encoded bitstream 132 incorporating the sequence of calibrated images is conveyed (e.g. transmitted or passed) to a display device 160. Examples of the display device 160 include an LCD television, a monitor, or a projector. The display device 160 includes an input to a video decoder 162 that decodes the calibrated images from the encoded bitstream 132 to produce video data, with the samples in each frame represented by decoded codewords 170. The decoded codewords 170 correspond to the codewords 130 of the HDR image 122, although are not exactly equal due to lossy compression techniques applied in the video encoder 114. The video decoder 162 also decodes metadata from the encoded bitstream 132, thus representing the calibration component of the images. The metadata can take any of the following forms: an auxiliary picture, a non-displayed portion of a frame, or an additional message (e.g. an SEI message). The metadata and the decoded codewords 170 are passed to a renderer 164. The renderer 164 uses the metadata to map the decoded codewords 170 to rendered samples 172. Generation of the map used by the renderer 164 is described later with reference to FIG. 9. The metadata required for these operations includes at least the black level, the reference diffuse white level and the peak white level of the encoding (or mastering) environment.

The display device 160 includes the panel device 166 that takes the rendered samples 172 as input to modulate the amount of backlight illumination passing through an LCD panel, such that the relationship between the decoded codewords 170 and light output from the panel device 166 accords with the EOTF in use by the display device 166. The panel device 166 is generally an LCD panel with an LED backlight. The LED backlight may include an array of LEDs to enable a degree of spatially localised control of the maximum achievable luminance. In such cases, the rendered samples 172 are separated into two signals, one for the intensity of each backlight LED and one for the LCD panel. The panel device 166 may alternatively use ‘organic LEDs’, in which case no separate backlighting is required. Other display approaches such as projectors are also possible, however the principle of a backlight and presence of the panel device 166 remain.

For the relative luminance (RL) case, the display device 160 generally includes brightness and contrast controls that enable the user to calibrate the display device 160 such that the decoded codeword values map to the intended luminance levels as required under the current viewing conditions, being those in the viewing environment in which the display device 160 is arranged. Generally, calibration is assisted by displaying a ‘picture line-up generation equipment’ (PLUGE) test pattern. The PLUGE test pattern generates blocks of various colours and shades of gray on the display device 160. Presented shades include black and reference white. A calibration procedure is defined that results in correct setting of the brightness and contrast controls for the viewing environment.

For the absolute luminance (AL) case, decoded codeword values 170 map to specific luminance levels in the mastering environment. In this case, decoded codeword values 170 are mapped to the panel drive signal via the renderer 164 such that the panel device 166 produces a light level determined by applying the EOTF to each codeword value in a given frame. In such a case, the rendered image is independent of differences between the viewing environment and the mastering environment. In practice, the renderer 164 may also take into account the ambient conditions, e.g. as measured by a light level sensor 165, to adjust the intensities (see FIG. 9). In one example of an AL signal representation, metadata is included in the encoded bitstream 132 that signals the light levels of black, reference diffuse white and peak white in the ‘mastering environment’. The mastering environment is the environment in which the content was ‘mastered’ or colour graded. Different types of content are mastered in different environments. For example, the mastering environment for an on-site live news broadcast is different (generally equipment in a mobile van) compared to a studio for producing a feature film. Moreover, for consumer content, mastering may not be performed, requiring an encoded bitstream 132 from the encoding device 110 that can be directly played on the display device 160 with high quality.

For both the RL, and the AL cases, the codeword values may be additionally transformed into a particular colour space in the encoded bitstream 132. Generally, samples from the source material 112 are representative of red, green and blue (RGB) intensities. Also, light output from the panel device 166 is generally specified as light intensities of light in the provided red, green, blue (RGB) primaries. As considerable correlation between these three colour components exist, a different colour space is generally used to encode these samples, such as YCbCr. The decoded codeword values 170 can thus represent intensities in the YCbCr colour space, with Y representing the luminance and Cb and Cr representing the colour (or ‘chroma’) components. Other colour spaces may also be used, such as LogLUV and CIELAB, offering the benefit of more uniform spread of perceived colour change across the codeword space used to encode the chroma components.

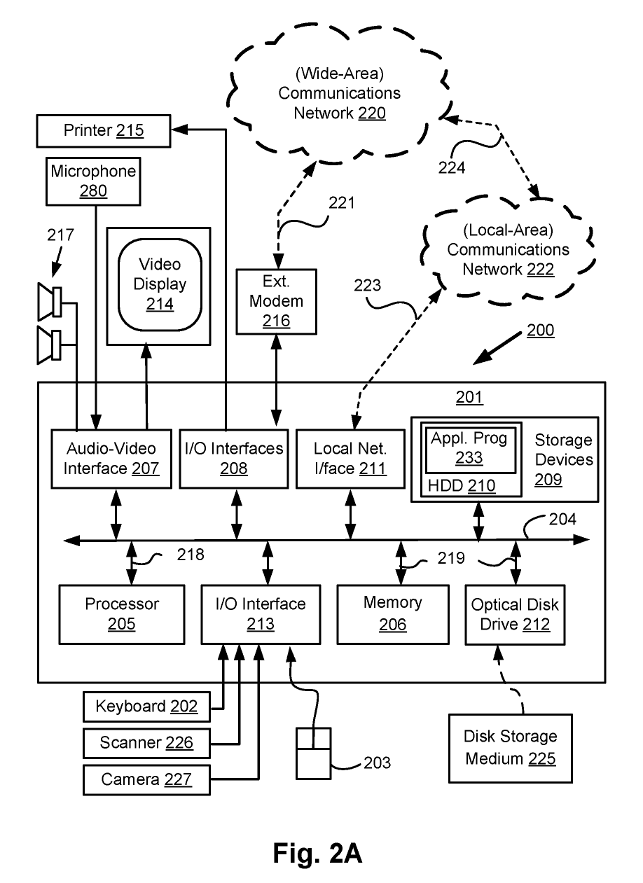

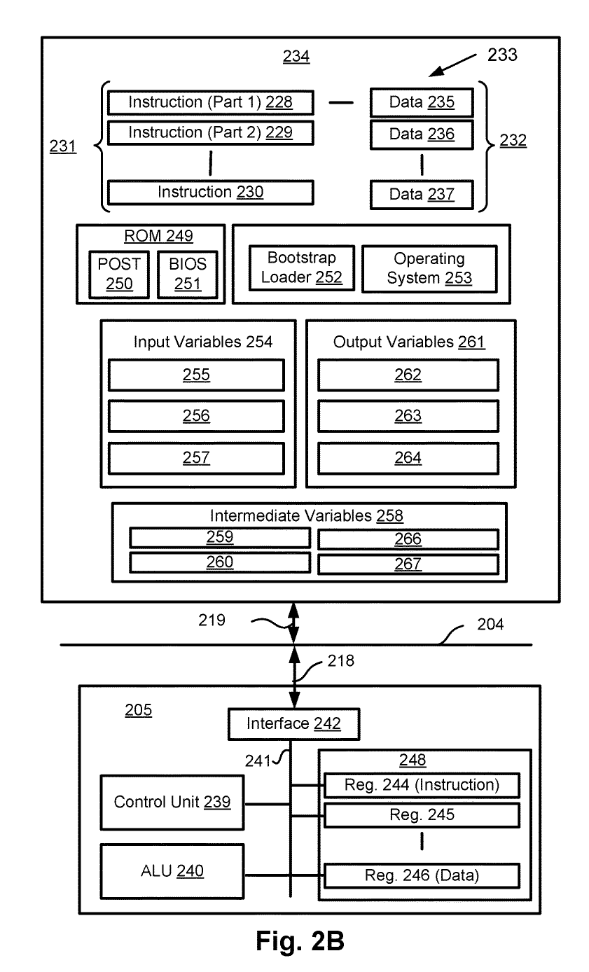

Notwithstanding the example devices mentioned above, each of the encoding device 110 and display device 160 may be configured within a general purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the source material 112, and a microphone 280; and output devices including a printer 215, a display device 214, which may be configured as the display device 160, and loudspeakers 217. An external Modulator-Demodulator (Modem) transceiver device 216 may be used by the computer module 201 for communicating to and from a communications network 220 via a connection 221. The communications network 220, which may represent the communication channel 150, may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220. The transceiver device 216 may additionally be provided in the encoding device 110 and the display device 160 and the communication channel 150 may be embodied in the connection 221.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card and provides an example of ‘screen content’. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may also provide the functionality of the communication channel 120 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g. CD-ROM, DVD, Blu-ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the source material 112, or as a destination for decoded video data to be stored for reproduction via the display 214. The HDD 210 may also represent a bulk storage whereby an encoded bitstream 132 for a video sequence may be stored for subsequent broadcast, distribution and/or reproduction. The encoding device 110 and the display device 160 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the video encoder 114 and the video decoder 162, as well as methods described below, may be implemented using the computer system 200 wherein the video encoder 114, the video decoder 162 and methods to be described, may be implemented as one or more software application programs 233 executable within the computer system 200. In particular, the video encoder 114, the video decoder 162 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the video encoder 114, the video decoder 162 and the described methods.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfill various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The video encoder 114, the video decoder 162 and the described methods may use input variables 254, which are stored in the memory 234 in corresponding memory locations 255, 256, 257. The video encoder 114, the video decoder 142 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from a memory location 228, 229, 230;

(b) a decode operation in which the control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

FIG. 3A is a schematic showing a calibration test pattern 300. A test pattern as used in the various arrangements described herein is associated with a particular set of the source material 122. The test pattern 300 includes regions of predetermined codeword values, such as regions 304-318 that, when displayed, show a fixed set of shades ranging from reference black to the reference diffuse white, indicative of the corresponding light levels in the source material 122. The test pattern 300 also includes a border region 302 that contains codewords corresponding to reference black. The region 318 shows the reference diffuse white level and the region 306 generally shows the mid-gray level, defined as 18% of the absolute luminance of the reference diffuse white level, which perceptually is half-way between the black level and the reference diffuse white level. The test pattern 300 can be an entire frame in size, or can be a small portion of a frame in size. The codewords of the test pattern 300 are determined by the test pattern generator 118 based upon the ambient conditions in the mastering environment. Thus, codewords encoding the light levels in the regions 302-320 vary with the mastering environment conditions.

FIG. 3B is a schematic showing another test pattern 330. The test pattern 330 includes colour bars 332, 334, 336, 338, 340, 342 and 344-350, having codeword values that correspond to pixel values of red, green and blue primaries and combinations thereof, including gray scale values. The test pattern 330 includes a reference black region 344, containing codewords corresponding to the black level in the mastering environment. The region 348 generally shows the reference black pixel level and several levels slightly above and below the reference black level, usable to assist calibration procedures. The test pattern 330 includes a reference diffuse white region 350, containing codewords corresponding to the reference diffuse white region in the mastering environment. Region 346 contains codewords at the 18% level in terms of luminance (i.e. 18% between reference black and reference diffuse white), that perceptually corresponds to half-way between reference black and reference diffuse white.

FIG. 3C shows another test calibration pattern 360 with regions 362-378 that, in addition to the peak white level region 378, includes additional white levels 370-376 above the reference diffuse white level 368 that can be present in the test pattern 360. For example, various multiples of the reference diffuse white level can be used. Examples of these multiples are indicated in FIG. 3C via ‘1×’ for reference diffuse white 368, and ‘2×’ for twice reference diffuse white 370. Several further regions, e.g. shown as ‘5×’ 372, ‘10×’ 374 and ‘20×’ 376 in FIG. 3C, representing higher multiples of reference diffuse white, up to the ‘Peak white’ 378 are also shown. The ‘Peak white’ region 378 would be 100× reference diffuse white 368 when the reference display is capable of emitting 10000 nits and the reference diffuse white level is 100 nits. The limit of 100× reference diffuse white is derived from a reference white level of 100 nits in a 10 lux SDR mastering environment and the PQ EOTF limit of 10000 nits. Also shown in FIG. 3C is a region ‘0×’ 364 which indicates the reference black level, and ‘0.18×’ 366 which indicates the mid-grey level, perceptually halfway between black and reference diffuse white. The calibration pattern 360 is contained within a border region 362. The border region 362 is not used for calibration purposes and generally contains reference black. As the border region 362 is not used for calibration purposes, some deviations from reference black are permissible. Such deviations may be useful to reduce the bit-rate of encoding the calibration pattern 360. The test pattern 360 is defined such that light levels from black to reference diffuse white (e.g., 0×, 0.18× and 1×) must accord with the defined light levels in the mastering environment, and the display device 160 must reproduce these light levels under various viewing conditions (within reason, e.g. excluding in direct sunlight). Then, regions defining luminances above the reference diffuse white may be clipped compared to the intended luminance due to limitation of the display used in the mastering environment. For example, if a 4000 nit mastering display were used, then the codeword value used in the ‘Peak white’ region 378 would actually correspond to a ‘40×’ luminance, assuming reference white of 100 nits. If a 1000 nit mastering display were used, then the codeword value used in the ‘Peak white’ region 378 would correspond to ‘10×’ luminance. In one arrangement of the system 100, the ‘20×’ region 376 would also be restricted to ‘10×’ rather than ‘20×’ luminance, to reflect the limitation imposed by the ‘Peak white’ region 378. In this way, a piecewise linear or sigmoidal model of deviation from the PQ EOTF for luminances above reference diffuse white can be established. The peak white level (i.e. the level assigned to the ‘Peak white’ region 378) indicates the maximum light level used in the mastering environment and thus the maximum codeword value to be expected in the displayed portion of the frame data.

In an arrangement of the system 100, the test pattern 134 (e.g. 300 or 330) includes white levels above the reference diffuse white level. For example, a peak white region (e.g. 308 or 346) may be present. The peak white region corresponds to the peak (i.e. highest or brightest) white level used by the encoding device 110. The limitation may be due to constraints on the mastering display, or due to natural limit of the transfer function used. For example, where the PQ EOTF is defined for 10000 nits, this represents the peak white (increasing beyond this limit, although theoretically possible, may result in step sizes exceeding the Barton threshold for human perception of brightness change). The display device 160 may have a different peak white level to that used by the encoding device 110. If the peak white level of the display device 160 exceeds the peak white level used by the encoding device 110, then the intended luminance can be reproduced by the display device 160 when the viewing environment matches the intended (or actual) environment used when mastering or capture.

FIG. 3D shows another calibration test pattern 380 intended for use in a frame packing arrangement (FPA). The test pattern 380 is equivalent to the test pattern 300, with the regions 304-318 rearranged to fit into a long narrow section of non-displayed frame. As such, the test pattern 380 is limited in height, e.g. the region 302 is 8 luma samples in height and the regions 304-318 are 4 luma samples in height. The width of the test pattern 380 desirably corresponds to the frame width, e.g. 3840 luma samples for an ultra-high definition frame size. As with the test pattern 300, the test pattern 380 includes a border region 302, which is typically reference black. The border 302 around the regions 304-318 provides a margin between the displayed portion (image content) of the frame to protect against artefacts impinging upon the test pattern 380. Those artefacts may otherwise result from inter prediction blocks that may fall slightly outside the displayed portion of the frame.

In an arrangement of the system 100, the encoded bitstream 134 includes metadata, such as a video usability information (VUI) or a supplemental enhancement information (SEI) message, indicating the deviation model for light levels above reference diffuse white, e.g. as described with reference to FIG. 3C. In such arrangements, the metadata is stored into the encoded bitstream 134 by the video encoder 114 and decoded from the video bitstream 134 by the video decoder 162.

In an absolute luminance system, specific codewords correspond to specific luminance levels, and thus the codewords corresponding to black and reference diffuse white are not constant. This is due to the fact that video content is mastered in a particular environment, which although well-defined, is not guaranteed to be consistent in practice. Thus, the specific codewords corresponding to black and reference diffuse white are not constant. The test patterns 300 and 330 are generated in the encoding device 110 to contain codewords for black and reference diffuse white that convey the correct levels in absolute luminance in accordance with the actual mastering environment.

FIGS. 4A and 4B are diagrams showing associations between test patterns and the video data. FIG. 4A shows a frame 400 subdivided into ‘coding tree units’ (CTUs) in accordance with the high efficiency video coding (HEVC) specification, such as may be implemented by the video encoder 114 and video decoder 162. The CTUs are sized 64×64, as such a size generally provides superior coding efficiency for high resolution content compared to smaller sizes, such as 16×16 or 32×32. At ultra-high definition (UHD) system supports a resolution of 3840×2160. This typically requires a CTU array of 60×34, with the lowermost row of CTUs cropped to accommodate the reduced resolution. Instead, in accordance with the present disclosure, a ‘frame packing arrangement’ (FPA) is used, whereby the CTU array is larger than the frame size and the extra frame area is a ‘non-displayed portion’ of the frame. Then, a decoded frame 402 (FIG. 4A) includes a displayed portion 406 and a non-displayed portion (being the decoded frame 402 less the displayed portion 406). A calibration pattern 404 is present in the non-displayed portion of the decoded frame 402. Due to the constrained height of the non-displayed portion of the frame, the calibration pattern 404 is necessarily more compact to fit within the short rectangular region afforded by the FPA. Alternatively, the size of the CTU array may be increased, e.g. to 60×35 for a UHD system, to provide additional area to contain the calibration pattern 404.

FIG. 4B shows a sequence of video frames 420, for example in accordance with the HEVC standard. The video frames 420 include auxiliary pictures 424 and 428, which are not directly displayed by the display device 160. Several types of auxiliary picture are defined in HEVC. For example, an ‘alpha channel’ is used when overlaying one set of video data onto another set of video data. Another example of an auxiliary picture type is a ‘depth map’, used to produce disparity (i.e. left field and right field) views of a frame for ‘3D’ video. According to the present disclosure, a ‘test pattern’ (or calibration pattern) auxiliary picture is also provided, whereby a test pattern is coded using a non-displayed auxiliary picture. In such a case, the test pattern can occupy the entire frame area, so no FPA need be used. The encoded bitstream 134 is structured such that decoding can begin at ‘random access pictures’, such as frames 422 and 426, within the encoded bitstream 134, that immediately precede the corresponding test pattern auxiliary pictures 424 and 428. As such, the encoded bitstream 132 includes additional auxiliary pictures that are not output for display in the display device 160, and thus the rate of encoding and decoding pictures may differ from the frame rate of the source material 122 and the panel device 166.

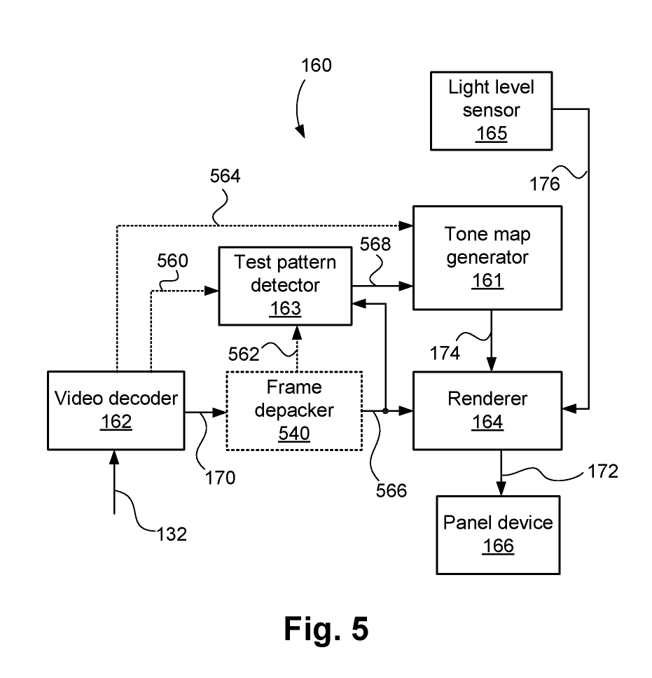

FIG. 5 is a schematic block diagram showing further detail of the video display system 160 of FIG. 1 suitable for multiple implementations. In arrangements of the display device 160 using an FPA, a frame depacker 540 is used when an SEI message is received by the video decoder 162 signalling use of an FPA. The frame depacker 540 separates decoded video data 170 into a displayed portion 566 (to be displayed on the panel device 166) and a non-displayed portion 562 (containing the test pattern). The non-displayed portion 562 is sent to the test pattern detector 163.

In arrangements of the display device 160 using an auxiliary picture, a side channel 560 is decoded by the decoder 162 when the test pattern is stored in the encoded bitstream 132 as an auxiliary picture. The side channel 560 conveys the auxiliary picture from the video decoder 162 to the test pattern detector 163. In such arrangements, the frame depacker 540 is not used for separating a non-displayed portion 562 from frame output of the video decoder 160 and, where the frame depacker 540 can be omitted, decoded codewords 170 of the video decoder 162 is passed directly to the renderer 164.

In arrangements of the display device 160 where the reference levels are present in the bitstream as metadata, such as an SEI message, a side channel 564 is decoded and conveys the reference levels from the video decoder 162 to the tone map generator 161. In such arrangements, the test pattern detector 163 is not used and can be omitted.

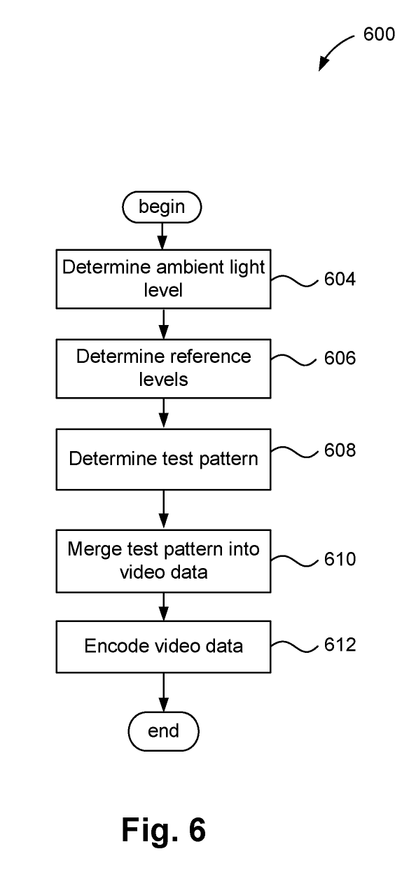

FIG. 6 is a schematic flow diagram showing a method 600 for encoding HDR video data with reference levels also encoded. The method 600 may be performed by apparatus (devices, components etc.) forming the encoding device 110, or in whole or part by an application program (e.g. 233) executing within the encoding device 110 or upon the processor 205 within the computer module 201.

The method 600 starts with a determine ambient light level step 604. At the determine ambient light level step 604, the encoding device 110, under control of the processor 205, determines the ambient light level in the mastering environment. The mastering environment can be a highly controlled environment such as a studio but can also be a relatively uncontrolled environment, such as an on-site production van. Where the mastering environment is a capture environment, particularly during instances of consumer (non-professional) use, the environment may be substantially uncontrolled. The light level sensor 115, under control of the processor 205, is used to measure the ambient light level 124 in the mastering environment. This measurement provides a baseline light level against which an image frame from the source material 112 can be interpreted. When deriving the tone-map for mapping sample values to codewords, the ambient light level 124 can be used instead of the average light level within the frame (or averaged across multiple frames). This provides a more stable tone-map, i.e. less reactive to variances in the captured data. Control in the processor 205 then passes to a determine reference levels step 606.

At the determine reference levels step 606, the encoding device 110, under control of the processor 205, determines the codeword values corresponding to the black level and the reference diffuse white level. As these codewords are not fixed in an absolute luminance system, it is necessary to determine suitable codewords for the environment in which the video data is being captured or the environment in which the video data is being prepared, such as the mastering environment. The reference black level is defined as the maximum codeword (light level) that can be output from a reference monitor in the mastering environment and nevertheless still be perceived as ‘black’ (i.e. indistinguishable from when no light is emitted from the reference monitor). Control in the processor 205 then passes to a determine test pattern step 608.

At the determine test pattern step 608, the encoding device 110, under control of the processor 205, determines a test pattern using the determined reference levels. For example, the test pattern 300 is generated and includes the black level 304 and the reference diffuse white level 312. Additionally intermediate grey tones 306, 308, 310, 314, 316 and 318 are generated. Control in the processor 205 then passes to a merge test pattern into video data step 610.

At the merge test pattern into video data step 610, the encoding device 110, under control of the processor 205, produces merged video data including, or representing an encoding of, both the HDR image 122 and the calibration pattern (e.g. 300, 330, 360 or 380).

In arrangements where a frame packing arrangement is used, the merging is performed by storing (or ‘packing’) an HDR image 122 and an associated calibration pattern into a larger image (e.g. 402) for encoding.

In an arrangement of the method 600, the calibration pattern is formed into an auxiliary picture in the encoded bitstream 132 by the encoder 114. In such arrangements, an auxiliary picture is included periodically in the encoded bitstream 132 so that the display device 160 receives correct information for rendering even where the entire encoded bitstream 132 is not received by the display device 160. In such arrangements, the encoded bitstream 132 includes encoded HDR images 122 interspersed with encoded auxiliary pictures (i.e. the calibration patterns). In such arrangements, the merge test pattern into video data step 610 is performed by the selection between HDR images 122 and auxiliary pictures as input to the video encoder 114, with suitable signalling to permit the video decoder 162 to extract the auxiliary pictures from the decoded versions of the HDR images 122. An example is where the display device 160 is a television receiver and is tuned to a new channel; then, earlier auxiliary pictures are not decoded by the display device 160. An auxiliary picture is encoded along with each random access picture in the encoded bitstream 132 to provide the same level of ‘random access’ (i.e. ability to being decoding from various frames other than the first frame of the encoded bitstream 132) capability as afforded by the HEVC standard. Control in the processor 205 then passes to an encode video data 612 step.

At the encode video data step 612, the video encoder 114, under control of the processor 205, encodes codeword values to produce an encoded bitstream 132. The codewords are derived from the sample values using the tone-map determined in the step 610. The method 600 then terminates.

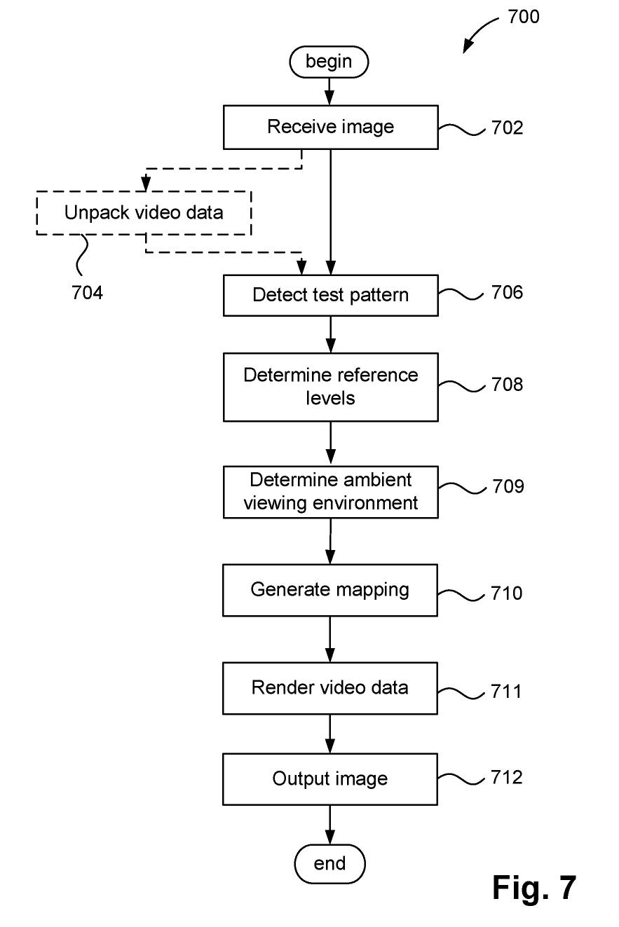

FIG. 7 is a schematic flow diagram showing a method 700 for decoding HDR video data and rendering the video data using detected reference levels. The method 700 may be performed by apparatus (devices, components etc.) forming the display device 160, or in whole or part by an application program (e.g. 233) executing within the display device 160 or upon the processor 205 within the computer module 201. The method 700 begins with a receive image step 702.

At the receive image step 702, a series of images, e.g. the decoded video data frames 170, are received. Generally, the receive image step 702 involves the video decoder 162, under control of the processor 205, decoding the encoded bitstream 132 to produce a series of decoded video data frames 170. During the receive image step 702, test patterns (e.g. 300 or 330) are also decoded from the encoded bitstream 132. In arrangements where an FPA is used to convey the test pattern, a ‘supplemental enhancement information’ (SEI) message is present in the encoded bitstream 132 and decoded by the video decoder 162 to signal the application of the FPA. In such arrangements, control in the processor 205 then passes to an unpack video data step 704. In arrangements where an auxiliary picture is used to convey the test pattern, control in the processor 205 then passes from step 702 to a detect test pattern step 706.

At the unpack video data step 704, the frame depacker 540, under control of the processor 205, separates video data received from the video decoder 162 into the displayed portion 566 and the non-displayed portion 562. For example, the region 406 of FIG. 4 would represent the displayed portion 566.

At the detect test pattern step 706, which follows each of steps 702 and 704, the test pattern detector 163, under control of the processor 205, checks any non-displayed portion 562 to determine if a predetermined test pattern is present or not. The choice of test pattern would generally be fixed in a given system. The non-displayed portion can include an auxiliary picture (e.g. 560) or can be the result of depacking a frame that was packed using an FPA (i.e. the non-displayed portion 562). The test pattern includes multiple regions having a specific relationship with each other (i.e. ratios between adjacent regions is known, but the absolute level and scaling is not known). For example, if the test pattern 360 is being used, then the regions ‘0×’, ‘0.18×’ and ‘1×’ would map to three corresponding absolute light levels when converting codewords to luminances using the PQ-EOTF. A linear relationship would be established using these three points. Then, the linear relationship is extended into a piecewise linear model by adding segments due to the additional regions, e.g. ‘2×’, ‘5×’. Up to a point, these extensions would generally be extensions of the initial linear relationship, however as limits of the reference display were reached, the extensions would deviate from this initial linear relationship. These deviations approximate a clipping operation, and so the gradient of the linear extensions reduces as the peak white level is reached. As the test pattern may be subject to lossy video compression in the video encoder 114, techniques to robustly detect the test pattern are used. For example, averaging many sample values within each region reduces the impact of block artefacts or quantisation noise, allowing more accurate recovery of the reference levels 128 by the test pattern detector 163. Also, as the ratio between different regions is known, but the absolute values are not known, the test pattern can be considered as detected if the averages within the regions meet the ratio requirements (within specific tolerances). Control in the processor 205 then passes to a determine reference levels step 708.

At the determine reference levels step 708, the test pattern detector 163, under control of the processor 205, determines reference levels 174, i.e. the black level, the reference diffuse white level, and the peak white level of the mastering display, using the levels detected in the regions of the step 706. If a test pattern was detected, then the average levels (i.e. as indicated by the average values of the codewords in the region) used in specific regions can be interpreted as the black level, reference diffuse white level, and peak white level of the mastering display. If the test pattern is not detected, then default values set within the test pattern detector 163 can be used. Exemplary default values include codeword 4 as black and codeword 520 as reference diffuse white (100 nits under 10 lux ambient lighting) for the PQ curve quantised to 10-bit precision. Control in the processor 205 then passes to a determine ambient viewing environment step 709.

At the determine ambient viewing environment step 709, the light level sensor 165, under control of the processor 205, determines the ambient light level in the viewing environment in which the display device 160 operates. The reference black level of the viewing environment and reference diffuse white level of the viewing environment are determined by the processor 205 according to the measured ambient light level. Control in the processor 205 then passes to a generate mapping step 710.

At the generate mapping step 710, the tone map generator 161, under control of the processor 205, generates a tone map, i.e. a set of values to be used in a look-up table (LUT), to convert decoded codewords 170 to rendered samples 172. An example tone map is described with reference to a render video data step 710 and with reference to FIG. 9. Control in the processor 205 then passes to the render video data step 711.

At the render video data step 711, the renderer 164, under control of the processor 205, renders the decoded codewords 170 to produce rendered samples 172. A two-stage mapping is applied whereby the reference levels are firstly used to interpret the decoded codewords 170. In the first stage of the mapping, decoded codewords representing luminance levels in accordance with the PQ-EOTF are effectively reinterpreted as ‘relative luminance’ codewords by virtue of their position relative to the determined reference black level, reference diffuse white level and peak white level. Then, a second mapping occurs based upon the ambient display light level 176, as detected by the light sensor 165. Control in the processor 205 then passes to an output image step 712. The second mapping effectively adapts the codewords from the first mapping to correspond to suitable levels for reference black, reference diffuse white and peak white in accordance with the ambient viewing environment. The first mapping and the second mapping can be performed consecutively, or they can also be combined into a single mapping step that embodies both conversions. FIG. 9 further describes the resulting single mapping generated in the generate mapping step 710 and applied in the render video data step 711.

At the output image step 712, the panel device 166 produces an image using the rendered samples 172, the rendered samples 172 having been generated from the decoded codewords of the encoded bitstream 134 in accordance with the render video data step 711. The method 700 then terminates.

FIG. 8 is a schematic showing a transfer function 800, such as the PQ-EOTF. The transfer function 800 includes a nonlinear map 802 of codewords, quantised to a particular precision, e.g. quantised to 10-bit precision, onto a set of absolute luminance levels, e.g. from 0 to 10,000 nits. The vertical axis depicts luminance levels and the horizontal axis depicts a perceptual levels (i.e. ‘lightness’), thereby providing the map 802 to link pixel values in the image 170 with pixel intensities to be displayed on the display panel device 166. In an ‘absolute luminance’ system, when the display device 160 uses the transfer function 800, the renderer 164 operates such that decoded codewords 170 result in luminance levels from the panel device 166 according to the nonlinear map 802. The transfer function 800 affords a wider range of luminances than likely to be reproduced on the reference display in the mastering environment. Thus, the range of codewords actually used in a given encoded bitstream 134 is typically restricted compared to the full range afforded by the bit-depth of the quantised perceptual domain, for example to between a black level 804 and a peak white level 808, with the majority of the codewords lying between the black level 804 and a reference diffuse white level 806.

In an arrangement of the encoding device 110, the tone-map is not dependent upon the adaptation parameters of the HVS model. In such arrangements, an SEI message is included in the bitstream that includes a map for converting decoded samples to a different sample representation, such as SDI codewords. For example, an ‘Output code Map’ SEI message may be used to convey a tone-map selected by the encoding device 110 and intended for use in the display device 160. When the maximum average light level for the video data would exceed the maximum comfortable viewing light level, the value stored in the SEI message is attenuated so that the final rendering in the display device 160 does not cause discomfort to viewers. As each frame is encoded in the encoded bitstream 132 by the video encoder 114, an additional SEI message may also be included (e.g. if the parameters to be stored differ from previously sent parameters).

FIG. 9 schematically represents an example tone map 900. The tone map 900 demonstrates the linked relationship between the decoded codewords 170 (pixel values) and the rendered samples 172 (pixel intensities). The tone map 900 is derived by the tone map generator 161 of FIG. 5 for use by the renderer 164 of FIGS. 1 and 5 for use in mapping decoded codewords to samples to drive the panel device 166. Depicted on each of the two scales are codeword values, e.g. subject to an implied range due to the bit-depth of the codewords. The range is further restricted by the convention to allow some ‘headroom’ above the maximum permitted codeword and some ‘footroom’ below the minimum permitted codeword. The headroom and footroom allows non-linear filters to be applied so minor excursions outside of the valid range are possible without requiring clipping. Such excursions are possible during intermediate processing, e.g. in a broadcast studio, but should not be present in a distributed bitstream. The decoded codewords scale depicts magnitudes from the minimum allowable codeword (e.g. 64) to the maximum allowed codeword (e.g. 940). Each codeword corresponds to a luminance level in accordance with the PQ curve, as described with reference to FIG. 8. Then, the range of codewords used in influenced by the mastering environment in which the content was prepared.

On the decoded codewords scale, three operative levels are shown: Reference black, reference diffuse white and peak white. Most of the signal (i.e. most codeword values) is expected to between black and reference diffuse white. A small amount of signal, corresponding to phenomena such as specular highlights, falls between reference diffuse white and peak white. The peak white level would generally result from the reference display used in the mastering environment, so a fixed maximum cannot be assumed. The rendered samples scale shows the range of sample values to be supplied to the panel device 166. As the display device 160 operates in a viewing environment, the video data must be reproduced such that all the detail present can be perceived by observers. Then, codewords must be mapped such that codewords corresponding to the black level in the content (i.e. from the mastering environment) map to a codeword corresponding to a black level in the viewing environment. If the black codeword of the content is mapped below the black level in the viewing environment, some detail in dark scenes will not be visible to the observer. If the black codeword of the content is mapped above the black level, then the display device 160 will appear to emit some background light even when the content should be entirely black. Then, the reference diffuse white level of the mastering environment is mapped to the reference diffuse white level of the viewing environment. Within the range from black to reference diffuse white, a linear mapping can be applied. If so, then the ‘gamma’ of this portion is 1. Generally, a non-linear mapping corresponding to a power function with an exponent of 1.2 or 1.6 (for darker environments) is applied. Then, content above the reference diffuse white is also mapped to the display. The maximum brightness the panel device 166 can produce is fixed, so as ambient light levels increase, the range afforded for highlights is reduced due to the corresponding increase in the reference diffuse white level in the viewing environment. The power function used between black and reference diffuse white can be extended to generate rendered samples from decoded codewords from reference diffuse white to peak white, however the codeword corresponding to the maximum display capability will be reached and all higher values must be clipped to this point. As this clipping is likely to introduce subjective artefacts into the content where highlights reach the peak white of the mastering environment, a transition from the extension of the power function to a linear model is performed for codeword values increasing from reference diffuse white to peak white, avoiding clipping while preserving the ‘contrast’ appropriate to the viewing environment as much as practical.

### INDUSTRIAL APPLICABILITY

The arrangements described are applicable to the computer and data processing industries and particularly for the digital signal processing for the encoding a decoding of signals such as video signals.

The foregoing describes only some embodiments of the present invention, and modifications and/or changes can be made thereto without departing from the scope and spirit of the invention, the embodiments being illustrative and not restrictive. For example, any form of coding may be used by the encoder 114 and decoder 162, these including those according to the HEVC and H.264 standards. Further, the arrangements presently disclosed apply not only to the encoding device 110 and the display device 160, but also to the bitstream 132 which represents a transitory manifestation of the calibrated image formed by the device 110 and able to reproduced by the device 160. The bitstream 132 may be stored on non-transitory media (such as the HDD 210, amongst others) thereby providing the non-transitory media to be a further physical manifestation of calibrated image formed by the device 110 and able to be reproduced by the device 160.

1. A method of displaying a calibrated image upon a display device, the method comprising:
receiving an image for display, the image having at least a portion of the image containing a calibration pattern with predetermined codeword values, the at least portion of the image being a non-displayed portion of the image, the predetermined codeword values encoding at least reference light levels of the image;
generating a mapping for the image using the reference light levels and ambient viewing conditions associated with the display device, the mapping linking codeword values of the image with light intensities of the display device; and
outputting the image on the display device using the generated mapping.

2. A method according to claim 1, wherein the encoding is performed in a mastering environment.

3. A method according to claim 1, wherein the reference light levels include at least a black level and a reference white level.

4. A method according to claim 1, wherein the display device is a high dynamic range display device.

5. A method according to claim 1, wherein the calibration pattern is contained in an auxiliary picture.

6. A method according to claim 1, wherein the calibration pattern is contained a frame packing arrangement.

7. A method according to claim 1, wherein the receiving comprises decoding an encoded bitstream of image data to provide the image having at least a portion containing the calibration pattern.

8. A method of forming a calibrated image sequence, comprising:
determining an ambient light level associated with an environment of the forming;
determining reference levels from the determined ambient light level;
forming a calibration test pattern associated with the reference levels; and
merging the calibration test pattern with video data of an image sequence to form the calibrated image sequence.

9. A method according to claim 8 further comprising:
encoding the calibrated image sequence as a bitstream.

10. A method according to claim 8 wherein the environment is one of:
a capture environment in which the image sequence is captured; and
a mastering environment.

11. A method according to claim 8 wherein the merging comprises forming encoding the calibration test pattern into one of an auxiliary picture or a frame packing arrangement associated with the video data of the image sequence.

12. A method according to claim 9 wherein the merging is performed by encoding video data interspersed with auxiliary pictures.

13. A non-transitory computer readable storage medium having recorded thereon an encoded calibrated image sequence formed by:
determining an ambient light level associated with an environment of the forming;
determining reference levels from the determined ambient light level;
forming a calibration test pattern associated with the reference levels;
merging the calibration test pattern with video data of an image sequence to form a calibrated image sequence; and
encoding the calibrated image sequence as a bitstream and storing the bitstream to the non-transitory computer readable storage medium.

14. A display device comprising:
an input for receiving an image for display, the image having at least a portion of the image containing a calibration pattern with predetermined codeword values, the at least portion of the image being a non-displayed portion of the image, the predetermined codeword values encoding at least reference light levels of the image;
a light level sensor to detect ambient viewing conditions associated with the display device;
a tone map generator for generating a mapping for the image using the reference light levels and the ambient viewing conditions, the mapping associating codeword values of the image with light intensities of the display device; and
an output for display of the image using the generated mapping.

15. A display device according to claim 14 wherein the output comprises:
a renderer where codeword values associated with the image are rendered according to the mapping and the ambient viewing conditions; and
a display panel by which the rendered codeword values are reproduced.

16. A display device according to claim 15, wherein the display device is a high dynamic range display device.

17. A display device according to claim 15, wherein the calibration pattern is contained in one of an auxiliary picture and a frame packing arrangement.

18. A display device according to claim 15, wherein the input comprises a decoder for decoding an encoded bitstream of the image data to provide the image having at least a portion containing the calibration pattern.
